(19) United States
(12) Patent Application Publication
(10) Pub. No.: US 2022/0072563 A1
(43) Pub. Date: Mar. 10, 2022

(54) CHAMBER FOR CENTRIFUGAL SEPARATION AND METHOD FOR CENTRIFUGAL SEPARATION USING THE SAME

(71) Applicant: CYTODX INC., Daejeon (KR)

(72) Inventors: Joseph SUNOO, Seongnam-si (KR); Min Pyo HONG, Suwon-si (KR)

(73) Assignee: CYTODX INC., Daejeon (KR)

(21) Appl. No.: 17/469,243

(22) Filed: Sep. 8, 2021

(30) Foreign Application Priority Data
Sep. 9, 2020 (KR) 10-2020-0115301

(51) Int. Cl. B04B 5/04; G01N 1/40

(52) U.S. Cl. CPC B04B 5/0442; B04B 2005/0478; G01N 1/4077

(57) ABSTRACT

A chamber for centrifugal separation includes a main body including a first opening and a second opening opposite to the first opening, a first cover coupled to the main body to close the first opening and including a first injection port to inject a material, a second cover coupled to the main body to close the second opening and including a second injection port to inject a material, and a filter device provided inside the main body and interposed between the first injection port and the second injection port, to prevent the material injected into the first injection port from being mixed with the material injected into the second injection port.

### CROSS-REFERENCE TO RELATED APPLICATION(S)

This application is based on and claims priority under 35 U.S.C. § 119 to Korean Patent Application No. 10-2020-0115301, filed on Sep. 9, 2020, in the Korean Intellectual Property Office, the disclosure of which is incorporated by reference herein its entirety.

### BACKGROUND

### 1. Field

The disclosure relates to a chamber for centrifugal separation and a method for centrifugal separation using the same.

### 2. Description of Related Art

A centrifuge may be used to extract peripheral blood mononuclear cells (PBMCs) or circulating tumor cell (CTCs) from blood. However, a remarkably small number of PBMCs or the CTCs are present in the blood, and, if the PBMCs or the CTCs are not separated within 24 hours after the blood of a person is collected, the cells may be destroyed. Accordingly, the PBMCs or the CTCs should be rapidly and exactly extracted.

Conventionally, after injecting a suspended density gradient material and blood into a container, such as a conical tube, and performing the centrifugal separation for the result, an extracting tool, such as a pipette, is inserted to a position, at which the separated PBMCs are placed to extract the PBMCs. However, as the suspended density gradient material and the blood are mixed before the centrifugal separation is performed, PBMCs or CTCs may be easily lost. In addition, because a person has a limitation in exactly inserting the extracting tool to the position, at which the PBMCs are placed, through a manual work, it is difficult to quantatively extract the PBMCs or the CTCs.

### SUMMARY

Aspects of the disclosure are to address at least the above-mentioned problems and/or disadvantages and to provide at least the advantages described below. Accordingly, an aspect of the disclosure is to provide a chamber for centrifugal separation and a method for centrifugal separation using the same, capable of easily extracting a target material to be extracted.

In accordance with an aspect of the disclosure, a chamber for centrifugal separation includes a main body including a first opening and a second opening opposite to the first opening, a first cover coupled to the main body to close the first opening and including a first injection port to inject a material, a second cover coupled to the main body to close the second opening and including a second injection port to inject a material, and a filter device provided inside the main body and interposed between the first injection port and the second injection port, to prevent the material injected into the first injection port from being mixed with the material injected into the second injection port.

In accordance with an aspect of the disclosure, the filter device may include a filter to filer a material and a first filter supporting member to mount the filter on the first filter supporting member, and a position of the first filter supporting member is fixed to an inner surface of the main body.

In accordance with an aspect of the disclosure, the main body may include a step part protruding inward from an inner surface of the main body. The filter device may further include a second filter supporting member extending from the first filter supporting member in a direction from the first injection port toward the second injection port. The position of the first filter supporting member may be fixed, as the second filter supporting member is supported by the second cover, and the surface, which faces the first cover, of the first filter supporting member makes contact with the step part, when the second cover is coupled to the second opening.

In accordance with an aspect of the disclosure, the second cover may include a protruding part protruding inward of the main body when the second cover is coupled to the main body. The second injection port may be formed in the protruding part. The chamber may further include a cap inserted into the second injection port in an axial direction to prevent the material, which is injected through the second injection port, from moving toward the first opening, when a direction parallel to the direction from the first opening toward the second opening is defined as the axial direction, and a direction perpendicular to the axial direction is defined as a radial direction.

In accordance with an aspect of the disclosure, the cap may include a pillar part formed to extend in the axial direction and inserted into the second injection port, a base part formed to extend in the radial direction from an end portion, which faces the first opening, of the pillar part, and a cover part extending in the axial direction from a circumference of the base part. A material injected through a flow path, which is formed between an inner circumferential surface of the second injection port and an outer circumferential surface of the pillar part, may be injected into the main body along a surface, which is at a side of the second injection port, of the base part and an inner surface of the cover part in the radial direction.

In accordance with an aspect of the disclosure, the protruding part may include an extending part formed in a hollow structure while extending in a direction parallel to the axial direction, to receive the pillar part, and a recess part provided in an outer circumferential surface of the pillar part to be recessed inward in the axial direction.

In accordance with an aspect of the disclosure, the main body may include a first main body unit in which a first opening is formed, a second main body unit in which a second opening is formed, and a connecting unit interposed between the first main body unit and the second main body unit. When a direction parallel to a direction from the first opening toward the second opening is defined as an axial direction, and a direction perpendicular to the axial direction is defined as a radial direction, the sectional area of the connecting unit in the radial direction may be narrower than sectional areas of the first main body unit and the second main body unit in the radial direction.

In accordance with an aspect of the disclosure, the second cover may include a second cover part to cover the second opening when coupled to the main body, and a second side part extending toward the first opening from a circumference of the second cover part to cover an outer surface of the main body. The second side part may include a roughness part having a repeated pattern formed along a circumference of an inner surface of the second cover part opposite to the outer surface of the main body. The main body may include a protruding part formed at a position corresponding to a position of the roughness part, and protruding to be engaged with the roughness part, when the second cover is coupled to the main body.

In accordance with an aspect of the disclosure, the second cover may be formed of a material having elasticity greater than elasticity of the protruding part.

In accordance with an aspect of the disclosure, a method for centrifugal separation by using a chamber for the centrifugal separation includes a main body including a first opening and a second opening opposite to the first opening, a first cover coupled to the main body to close the first opening and including a first injection port to inject a material, a second cover coupled to the main body to close the second opening and including a second injection port to inject a material, and a filter device provided inside the main body and interposed between the first injection port and the second injection port, to prevent the material injected into the first injection port from being mixed with the material injected into the second injection port, includes preparing the chamber for the centrifugal separation, injecting a density gradient material through the second injection port, injecting a target material for the centrifugal separation through the first injection port, performing the centrifugal separation for the target material for the centrifugal separation by rotating the chamber for the centrifugal separation, and extracting a target material to be extracted after the centrifugal separation, through the first injection port.

In accordance with an aspect of the disclosure, the main body may include a first main body unit in which the first opening is formed, a second main body unit in which the second opening is formed, and a connecting unit interposed between the first main body unit and the second main body unit. A sectional area of the connecting unit in a radial direction may be narrower than sectional areas of the first main body unit and the second main body unit in the radial direction, when a direction parallel to a direction from the first opening toward the second opening is defined as an axial direction, and a direction perpendicular to the axial direction is defined as the radial direction. The method may further include injecting the density gradient material again through the second injection port again such that the target material to be extracted is positioned in the connecting unit, after injecting the target material for the centrifugal separation. The extracting of the target material to be extracted may include extracting the target material to be extracted by inserting an extracting tool to the connecting unit through the first injection port.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a perspective view illustrating a chamber for centrifugal separation, according to an embodiment of the disclosure;

FIG. 2 is a front sectional view illustrating a chamber for centrifugal separation, according to an embodiment of the disclosure;

FIG. 3 is an exploded perspective view illustrating a chamber for centrifugal separation, according to an embodiment of the disclosure;

FIG. 4 is a perspective view illustrating a second cover and a cap, according to an embodiment of the disclosure;

FIG. 5 is a partially cut-out perspective view illustrating a second cover, according to an embodiment of the disclosure;

FIG. 6 is a perspective view illustrating a second cover coupled to a second main body unit, according to an embodiment of the disclosure;

FIG. 7 is a plan view illustrating a second cover, according to an embodiment of the disclosure; and

FIG. 8 illustrates views to explain a method for centrifugal separation using a chamber for centrifugal separation, according to an embodiment of the disclosure.

### DETAILED DESCRIPTION

Hereinafter, various embodiments of the disclosure will described with reference to accompanying drawings. However, those of ordinary skill in the art should understand that the disclosure is not limited to a specific embodiment, and modifications, equivalents, and/or alternatives on the various embodiments described herein can be variously made without departing from the scope and spirit of the disclosure. With regard to description of drawings, similar components may be assigned with similar reference numerals

In the disclosure, it will be further understood that the terms “have”, “can have,” “includes” and/or “can include”, when used herein, specify the presence of stated features (for example, components such as a numeric value, a function, an operation, or a part), but do not preclude the presence or addition of one or more other features.

In the disclosure, the expressions “A or B”, “at least one of A and/or B”, “one or more of A and/or B” may include all possible combinations of one or more of the associated listed items. For example, “A or B”, “at least one of A and B”, or “at least one of A or B” includes all (1) at least one A, (2) at least one B, or (3) at least one “A” and at least one “B”.

The wording “˜ configured to” used in the disclosure can be interchangeably used with, for example, “suitable for”, “having the capacity to”, “designed to”, “adapted to”, “made to”, or “capable of”. The wording “configured to” does not refer to essentially “specifically designed to”.

The terms in the disclosure are used only for specific embodiments, and the scope of another embodiment is not limited thereto. The terms of a singular form may include plural forms unless otherwise specified. In addition, unless otherwise defined, all terms used in the disclosure, including technical or scientific terms, have the same meanings as those generally understood by those skilled in the art to which the disclosure pertains. Such terms, which are used herein, as those defined in a generally used dictionary are to be interpreted as having meanings equal to the contextual meanings in the relevant field of art, and are not to be interpreted as having ideal or excessively formal meanings unless clearly defined as having such in the disclosure. Even if the terms are defined in the disclosure, the terms should not be interpreted as excluding embodiments of the disclosure if necessary.

The embodiment disclosed herein should be suggested for the convenience of explanation, and should not limit the scope of the disclosure. Accordingly, the technical scope of the disclosure should be interpreted as including all modifications or various changes based on the technical spirit of the disclosure

Hereinafter, the embodiment of the disclosure will be described in detail. Before the description of the embodiment, terms and words used in the present specification and the claims should not be interpreted as commonly-used dictionary meanings, but should be interpreted as to be relevant to the technical scope of the disclosure based on the fact that the inventor may properly define the concept of the terms to explain the disclosure in best ways

Therefore, features of the embodiment described in the disclosure are only part of the most exemplary embodiments of the disclosure, and do not represent all technical scopes of the embodiments, so it should be understood that various equivalents and modifications could exist at the time of filing this application

Throughout the whole specification, when a certain part “includes” a certain component, the certain part does not exclude other components, but may further include other components unless there is a specific opposite description

Hereinafter, the disclosure will be described in detail.

### Chamber for Centrifugal Separation

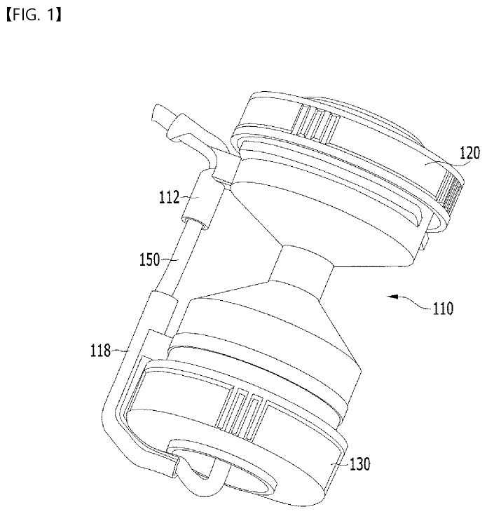

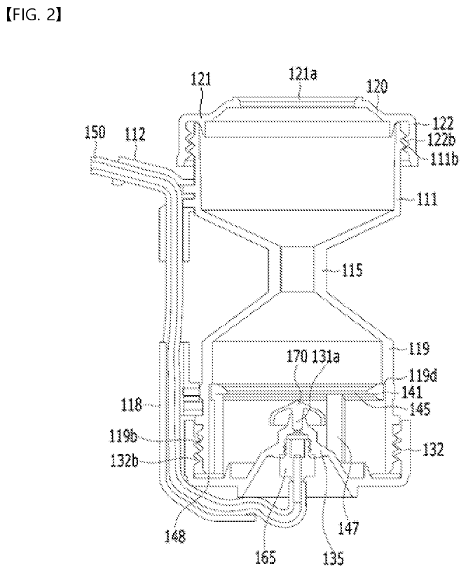

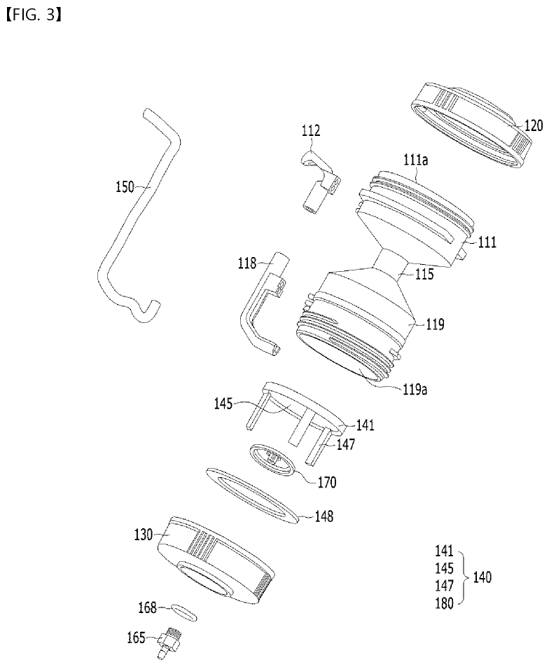

FIG. 1 is a perspective view illustrating a chamber for centrifugal separation, according to an embodiment of the disclosure. FIG. 2 is a front sectional view illustrating a chamber for centrifugal separation, according to an embodiment of the disclosure. FIG. 3 is an exploded perspective view illustrating a chamber for centrifugal separation, according to an embodiment of the disclosure. Hereinafter, a chamber for centrifugal separation will be described with reference to FIGS. 1 to 3.

According to an embodiment of the disclosure, the chamber for centrifugal separation includes a main body 110, a first cover 120, a second cover 130, and a filter device 140.

According to an embodiment of the disclosure, the filter device 140 not only serves as an inter-layer boundary to prevent injected materials from being mixed with each other, but also splits pressure applied when the injected materials are mixed and introduced into the chamber, thereby preventing the injected materials from being mixed and introduced due to the pressure concentrated on a portion of each inter-layer interface when the materials are injected. In other words, inventors could understand that a filter is disposed in the chamber to stabilize the inter-layer interface by splitting the pressure such that a material having higher purity is separated, instead of separating each material layer.

Referring to FIGS. 2 and 3, the main body 110 includes a first main body unit 111, a second main body unit 119, and a connecting unit 115. The first main body unit 111 includes a first opening 111a formed in the first main body unit 111, and the second main body unit 119 includes a second opening 119a formed in the second main body unit 119 and opposite to the first opening 111a. The connecting unit 115 is interposed between the first main body unit 111 and the second main body unit 119 to connect the first main body unit 111 with the second main body unit 119.

The first main body unit 111, the second main body unit 119, and the connecting unit 115 may in a cylindrical shape, but the disclosure is not limited thereto. In addition, the first main body unit 111 and the second main body unit 119 may include an upper fixing unit 112 and a lower fixing unit 118 to fix a tube 150, which is to be described below, to the main body 110, respectively. In addition, when defining, as a chamber axial direction, a direction parallel to a direction from the first opening 111a toward the second opening 119a, and defining, as a chamber radial direction, a direction perpendicular to the chamber axial direction, the sectional area of the connecting unit 115 in the chamber radial direction is formed to be narrower than the sectional areas of the first main body unit 111 and the second main body unit 119 in the chamber radial direction.

The first cover 120 is coupled to the first main body unit 111 of the main body 110 to close the first opening 111a, and the second cover 130 is coupled to the second main body unit 119 of the main body 110 to close the second opening 119a. The first cover 120 includes a first injection port 121a formed in the first cover 120, and the second cover 130 includes a second injection port 131a formed in the second cover 130. The details of the first cover 120 and the second cover 130 will be described below in more details.

The filter device 140 is interposed between the first injection port 121a and the second injection port 131a inside the main body 110. The filter device 140 prevents a material injected into the first injection port 121a and a material injected into the second injection port 131a, from being mixed with each other. As the filter device 140 is provided to prevent the materials, which are injected through the first injection port 121a and the second injection port 131a, from being mixed with each other before centrifugal separation, the target material to be extracted may be smoothly separated after the centrifugal separation.

The filter device 140 includes a filter 145 to filter a material, and a first filter supporting member 141 to mount the filter 145 on the first filter supporting member 141. The position of the first filter supporting member 141 is fixed between the first injection port 121a and the second injection port 131a inside the main body 110. Accordingly, the filter 145 prevents the material injected through the first injection port 121a and the material injected through the second injection port 131a from being mixed with each other.

The filter 145 may be, for example, a mesh filter 145 formed of nylon, polyester, polypropylene, or polyetheretherketone (PEEK). A mesh pore may have a circular shape, an oval shape, or a polygonal shape, and may have the size ranging from 5 μm to 600 μm, but the disclosure is not limited thereto. In addition, the filter 145 is not limited to the mesh filter, but may include various filters, such as a membrane.

Meanwhile, a manner of fixing the position of the first filter supporting member 141 in the chamber axial direction is not specifically limited. According to an embodiment of the disclosure, the filter device 140 includes a plurality of second filter supporting members 147 to support the first filter supporting member 141 such that the position of the first filter supporting member 141 is fixed to a specific position.

In more detail, the second filter supporting member 147 is formed to extend from the first filter supporting member 141 in a direction from the first injection port 121a to the second injection port 131a. The second filter supporting member 147 has a pillar form. A plurality of second filter supporting members 147 may be provided. In addition, a step part 119d is formed to protrude inward from an inner surface of the main body 110.

Accordingly, when the second cover 130 is coupled to the second main body unit 119, the second filter supporting member 147 is supported by the second cover 130 and pressed toward the first opening 111a, and the first filter supporting member 141 connected with the second filter supporting member 147 is displaced toward the first opening 111a. However, because the step part 119d is formed on the inner surface of the main body 110, a surface, which faces the first opening 111a, of the first filter supporting member 141 makes contact with the step part 119d, such that the first filter supporting member 141 is blocked from being displaced toward the first opening 111a. Accordingly, the first filter supporting member 141 may be fixed in the position in the chamber axial direction, between the step part 119d and the second filter supporting member 147. In other words, the second filter supporting member 147 may be formed to have a length supported by the second cover 130 while the first filter supporting member 141 makes contact with the step part 119d, when the second cover 130 is coupled to the main body 110.

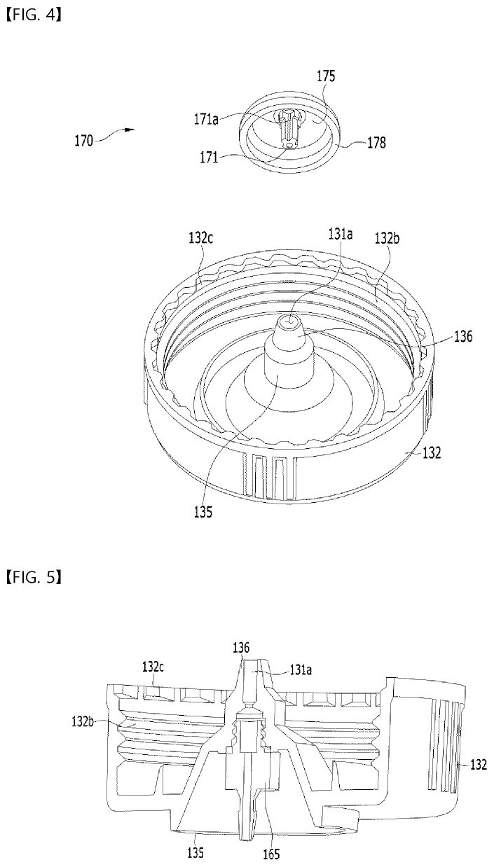

FIG. 4 is a perspective view illustrating a second cover and a cap, according to an embodiment of the disclosure. FIG. 5 is a partially cut-out perspective view illustrating a second cover, according to an embodiment of the disclosure. Hereinafter, the first cover 120 and the second cover 130 will be described in more detail with reference to FIGS. 2 to 5.

First, referring to FIGS. 2 and 3, the first cover 120 includes a first cover part 121 to close the first opening 111a when coupled to the main body 110, and a first side part 122 extending from a circumference of the first cover 120 to surround an outer surface of the first main body unit 111. The first cover part 121 includes the first injection port 121a to inject a material into the main body 110. In addition, thread parts 122b and 111b to be engaged with each other are formed on an inner surface of the first side part 122 and on an outer circumferential surface of the first main body unit 111, respectively, such that the first cover 120 is thread-engaged with the first main body unit 111.

Meanwhile, a target material, such as blood, for centrifugal separation may be injected into the first injection port 121a or a target material to be extracted after the centrifugal separation may be extracted through the first injection port 121a For example, a syringe or pipette may be inserted into the main body 110 through the first injection port 121a to inject the blood or to extract the separated PBMC.

First, referring to FIGS. 2 to 5, the second cover 130 includes a second cover part 131 to close the second opening 119a when coupled to the main body 110, and a second side part 132 extending from a circumference of the second cover part 131 to surround an outer surface of the second main body unit 119. In addition, thread parts 132b and 119b to be engaged with each other are formed on an inner surface of the second side part 132 and on an outer circumferential surface of the second main body unit 119, respectively, such that the second cover 130 is thread-engaged with the second main body unit 119. In addition, a second cover packing member 148 is interposed between the second cover part 131 and the second opening 119a to firmly seal the second opening 119a.

Meanwhile, the second cover part 131 includes a protruding part 135 protruding inward of the main body 110, when the second cover 130 is coupled to the main body 110. The protruding part 135 may extend such that a distal end of the protruding part 135 becomes closer to the second opening 119a rather than the filter 145 of the filter device 140. In addition, an extending part 136 is formed in a hollow structure while extending from the distal end of the protruding part 135 toward the first opening 111a, and the second injection port 131a is formed in the extending part 136 in the hollow structure. Meanwhile, a tube connector 165 may be fitted into the second injection port 131a while interposing a tube packing member 168 between the tube connector 165 and the second injection port 131a. The material injected through the tube 150 is injected into the main body 110 after passing through the tube connector 165 and the second injection port 131a.

In this case, a cap 170 is inserted into the second injection port 131a in the chamber axial direction to prevent the material, which is injected through the second injection port 131a, from moving toward the first opening 111a. Accordingly, even if the material is injected into the second injection port 131a in the status that a plurality of ingredients are separated in the chamber axial direction after centrifugal separation, the material is prevented from moving toward the first opening 111a, such that the plurality of ingredients are prevented from being mixed with each other.

In more detail, the cap 170 may include a pillar part 171, a base part 175, and a cover part 178. The pillar part 171 refers to a part formed to extend in the chamber axial direction and inserted into the second injection port 131a. The base part 175 refers to a part formed to extend in the chamber radial direction from an end portion, which faces the first opening 111a, of the pillar part 171. The cover part 178 refers to a part extending in the chamber axial direction from a circumference of the base part 175. Accordingly, a flow path is formed between an inner circumferential surface of the second injection port 131a and an outer circumferential surface of the pillar part 171. A material injected through the flow path may be injected into the main body 110 along a surface, which faces the second injection port 131a, of the base part 175 and an inner surface of the cover part 178 in a radial direction. In other words, the material injected into the second injection port 131a may be prevented from moving toward the first opening 111a.

In this case, a plurality of recess parts 171a are provided in an outer circumferential surface of the pillar part 171 to be recessed inward in the pillar part 171 axial direction. Accordingly, a flow path may be expanded to inject a larger amount of a material through the second injection port 131a.

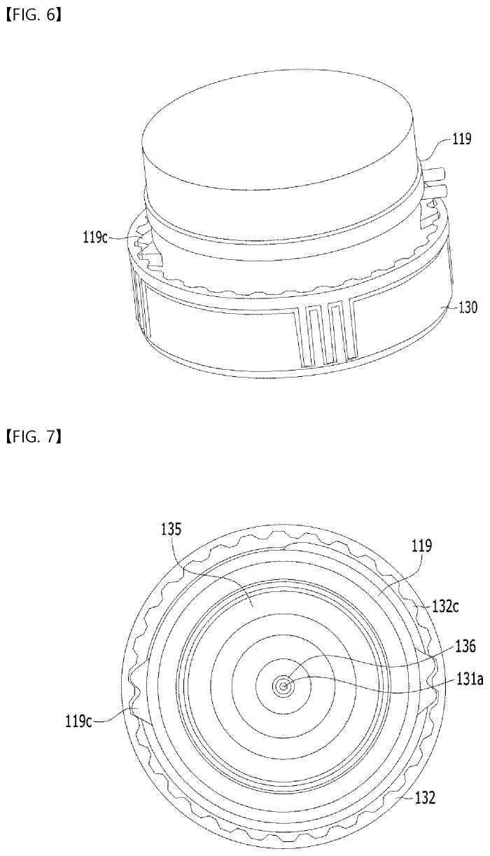

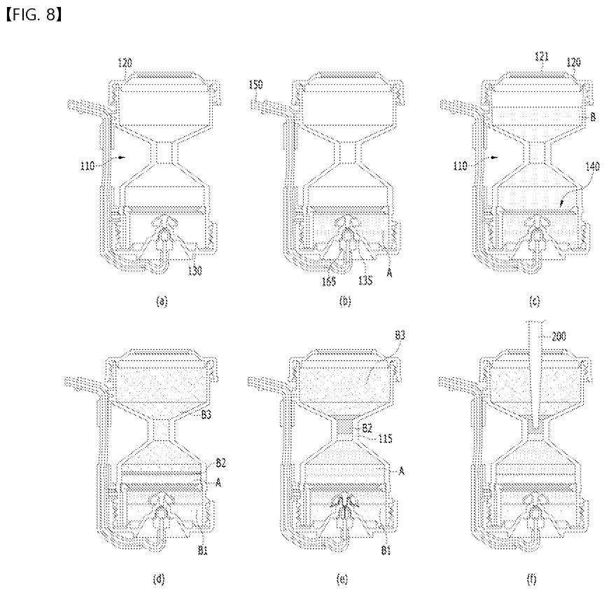

FIG. 6 is a perspective view illustrating a second cover coupled to a second main body unit, according to an embodiment of the disclosure. FIG. 7 is a plan view illustrating a second cover, according to an embodiment of the disclosure. Hereinafter, a coupling manner and a separating manner between the second cover 130 and the second main body unit 119 will be described with respect to FIGS. 6 and 7.

Although the following description will be made while focusing on the second cover 130, the substantially same features are applicable to the first cover 120.

Referring to FIGS. 6 and 7, a roughness part 132c is formed by consecutively and alternately arranging a concave part and a convex part in a circumferential direction on the inner surface of the second side part 132 of the second cover 130. In addition, a plurality of protruding parts 119c are formed to protrude from an outer surface of the second main body unit 119 to be engaged with the roughness part 132c. Although two protruding parts 119c protrude in the shape of “M”, the protruding parts 119c are not specifically limited in number and in shape.

The protruding part 119c is formed at a position corresponding to a position of the roughness part 132c in the chamber axial direction, when the second cover 130 is coupled to the main body 110. Accordingly, when the second cover 130 is coupled to the main body 110, the protruding part 119c is engaged with the roughness part 132c having a repeated pattern along the circumference of the second cover 130, thereby preventing the second cover 130 from being separated from the main body 110, that is, preventing the second cover 130 from being rotated.

In addition, the protruding part 119c may be formed of a hard material having relatively less elasticity, and the second cover 130 may be formed of a flexible material having relatively higher elasticity. Accordingly, when force is applied to the second cover 130 to couple the second cover 130 to the main body 110 or to separate the second cover 130 from the main body 110, the shape of the second cover 130 is deformed (for example, a circular shape is changed to an oval shape) to release the engagement between the protruding part 119c and the roughness part 132c. Accordingly, the coupling and the separation of the second cover 130 may be easily performed.

### Method for Centrifugal Separation

FIG. 8 illustrates views to explain a method for centrifugal separation using a chamber for centrifugal separation, according to an embodiment of the disclosure. Reference signs (a) to (c) of FIG. 8 are views illustrating a procedure before centrifugal separation, and reference signs (d) to (f) of FIG. 8 are views illustrating a procedure after the centrifugal separation. The following description will be made regarding a manner of extracting a PBMC from blood by performing the centrifugal separation for the blood. However, a target material for centrifugal separation and a target material to be extracted are not specifically limited.

First, according to an embodiment of the disclosure, a chamber for centrifugal separation is prepared (see reference sign (a) of FIG. 8). The chamber for centrifugal separation includes the main body 110, the first cover 120, the second cover 130, and the filter device 140. In addition, the tube 150 is mounted on the main body 110 to be inserted into the second injection port 131a of the second cover 130.

When the chamber for the centrifugal separation is prepared, a density gradient material “A” is supplied to the tube 150. As described above, the density gradient material “A” supplied to the tube 150 is injected into the main body 110 after passing through the tube connector 165 and the second injection port 131a (see reference sign (b) of FIG. 8).

Next, blood “B” is injected into the main body 110 through the first injection port 121a (see reference sign (c) of FIG. 8). The blood “B” may be injected by inserting a syringe or pipette into the first injection port 121a. In this case, because the filter device 140 is provided inside the main body 110, the blood “B” and the density gradient material “A” may be prevented from being mixed with each other.

In this status, the centrifugal separation is performed after mounting the chamber for centrifugal separation in an apparatus for centrifugal separation. Accordingly, plasma “B3”, PBMC “B2”, the density gradient material “A”, and a red blood cell “B1” are separated and sequentially positioned in the direction from the first opening 111a toward the second opening 119a (see reference sign (d) of FIG. 8).

In this status, the density gradient material “A” is injected again into the main body 110 (see reference sign (e) of FIG. 8). As described above, the main body 110, which includes the connecting unit 115 having a smaller sectional area, supplies the density gradient material “A” to lift the PBMC “B2” to the position of the connecting unit 115 such that the PBMC “B2” serving as the target material to be extracted is easily extracted. In this case, because the cap 170 is coupled to the second injection port 131a, the density gradient material “A”, which is supplied again, is prevented from moving toward the first opening 111a. Accordingly, even if the density gradient material “A” is injected again, the plasma “B3”, the PBMC “B2”, the density gradient material “A”, and the red blood cell “B1” are prevented from being mixed with each other. In addition, even the filter device 140 may prevent the separated ingredients from being mixed with each other again. In detail, the filter device 140 may partially block a vortex, which is generated when the density gradient material “A” is injected, from being propagated to the boundary surface between the PBMC “B2” and the density gradient material “A”, which are positioned at an upper portion. Accordingly, the filter device 140 may prevent the PBMC “B2” from being mixed with another ingredient due to the vortex of the density gradient material “A”.

When the PBMC “B2” is placed at the position of the connecting unit 115, an extracting tool 200 is inserted till the position of the connecting unit 115 through the first injection port 121a to extract the PBMC “B2” (see reference sign (f) of FIG. 8). The procedure of lifting the PBMC “B2” to the position of the connecting unit 115 by injecting the density gradient material “A” again may make the target material conveniently and exactly extracted merely through a control work of inserting the extracting tool 200 till the position of the connecting unit 115.

According to the chamber for the centrifugal separation of the disclosure, the density gradient material, which is injected before the centrifugal separation, is prevented from being mixed with the target material for the centrifugal separation by the filter device, thereby preventing the target material to be extracted from being lost.

In addition, as the cap is coupled to the second injection port, the material injected through the second injection port is prevented from moving toward the first opening, thereby preventing the separated ingredients from being mixed with each other, and more preventing the target material to be extracted from being lost.

Hereinabove, although the disclosure has been described with reference to exemplary embodiments and the accompanying drawings, the disclosure is not limited thereto, but may be variously modified and altered by those skilled in the art to which the disclosure pertains without departing from the spirit and scope of the disclosure claimed in the following claims. Therefore, the exemplary embodiments of the disclosure are provided to explain the spirit and scope of the disclosure, but not to limit them, so that the spirit and scope of the disclosure is not limited by the embodiments. The scope of the disclosure should be construed on the basis of the accompanying claims, and all the technical ideas within the scope equivalent to the claims should be included in the scope of the disclosure.

What is claimed is:

1. A chamber for centrifugal separation, comprising:
a main body including a first opening and a second opening opposite to the first opening;
a first cover coupled to the main body to close the first opening, and including a first injection port to inject a material;
a second cover coupled to the main body to close the second opening, and including a second injection port to inject a material; and
a filter device provided inside the main body and interposed between the first injection port and the second injection port, to prevent the material injected into the first injection port from being mixed with the material injected into the second injection port.

2. The chamber of claim 1, wherein the filter device includes:
a filter to filter a material; and
a first filter supporting member to mount the filter on the first filter supporting member, a position of the first filter supporting member being fixed to an inner surface of the main body.

3. The chamber of claim 2, wherein the main body includes:
a step part protruding inward from the inner surface of the main body,
wherein the filter device further includes:
a second filter supporting member extending from the first filter supporting member in a direction from the first injection port toward the second injection port, and
wherein the position of the first filter supporting member is fixed,
as the second filter supporting member is supported by the second cover, and a surface, which faces the first cover, of the first filter supporting member makes contact with the step part, when the second cover is coupled to the second opening.

4. The chamber of claim 1, wherein the second cover includes:
a protruding part protruding inward of the main body, when the second cover is coupled to the main body,
wherein the second injection port is formed in the protruding part, and
wherein the chamber further includes:
a cap inserted into the second injection port in an axial direction to prevent the material, which is injected through the second injection port, from moving toward the first opening,
when a direction parallel to a direction from the first opening toward the second opening is defined as the axial direction, and a direction perpendicular to the axial direction is defined as a radial direction.

5. The chamber of claim 4, wherein the cap includes:
a pillar part formed to extend in the axial direction and inserted into the second injection port;
a base part formed to extend in the radial direction from an end portion, which is at a side of the first opening, of the pillar part; and
a cover part extending in the axial direction from a circumference of the base part, and
wherein a material injected through a flow path, which is formed between an inner circumferential surface of the second injection port and an outer circumferential surface of the pillar part, is injected into the main body along a surface, which is at a side of the second injection port, of the base part and an inner surface of the cover part in the radial direction.

6. The chamber of claim 5, wherein the protruding part includes:
an extending part formed in a hollow structure while extending in a direction parallel to the axial direction, to receive the pillar part; and
a recess part provided in an outer circumferential surface of the pillar part to be recessed inward in the axial direction.

7. The chamber of claim 1, wherein the main body includes:
a first main body unit in which the first opening is formed;
a second main body unit in which the second opening is formed; and
a connecting unit interposed between the first main body unit and the second main body unit, and
wherein a sectional area of the connecting unit in a radial direction is narrower than sectional areas of the first main body unit and the second main body unit in the radial direction,
when a direction parallel to a direction from the first opening toward the second opening is defined as an axial direction, and a direction perpendicular to the axial direction is defined as the radial direction.

8. The chamber of claim 1, wherein the second cover includes:
a second cover part to cover the second opening when coupled to the main body; and
a second side part extending toward the first opening from a circumference of the second cover part to cover an outer surface of the main body,
wherein the second side part includes:
a roughness part having a repeated pattern formed along a circumference of an inner surface of the second side part, which is opposite to the outer surface of the main body, and
wherein the main body includes:
a protruding part formed at a position corresponding to a position of the roughness part, and protruding to be engaged with the roughness part, when the second cover is coupled to the main body.

9. A method for centrifugal separation by using a chamber for the centrifugal separation,
the chamber including a main body including a first opening and a second opening opposite to the first opening, a first cover coupled to the main body to close the first opening and including a first injection port to inject a material, a second cover coupled to the main body to close the second opening and including a second injection port to inject a material, and a filter device provided inside the main body and interposed between the first injection port and the second injection port, to prevent the material injected into the first injection port from being mixed with the material injected into the second injection port,
the method comprising:
preparing the chamber for the centrifugal separation;
injecting a density gradient material through the second injection port;
injecting a target material for the centrifugal separation through the first injection port;
performing the centrifugal separation with respect to the target material for the centrifugal separation by rotating the chamber for the centrifugal separation; and
extracting a target material to be extracted after the centrifugal separation, through the first injection port.

10. The method of claim 9, wherein the main body includes a first main body unit in which the first opening is formed, a second main body unit in which the second opening is formed, and a connecting unit interposed between the first main body unit and the second main body unit,
wherein a sectional area of the connecting unit in a radial direction may be narrower than sectional areas of the first main body unit and the second main body unit in the radial direction, when a direction parallel to a direction from the first opening toward the second opening is defined as an axial direction, and a direction perpendicular to the axial direction is defined as the radial direction,
wherein the method further includes:
injecting the density gradient material again through the second injection port again such that the target material to be extracted is positioned in the connecting unit, after injecting the target material for the centrifugal separation, and
wherein the extracting of the target material to be extracted includes:
extracting the target material to be extracted by inserting an extracting tool into the connecting unit through the first injection port.
